(19) United States
(12) Patent Application Publication
(10) Pub. No.: US 2014/0251063 A1
(43) Pub. Date: Sep. 11, 2014

(54) CABLE FOR A VEHICLE

(71) Applicant: Yuan-Hung WEN, Chang Hua County (TW)

(72) Inventor: Yuan-Hung WEN, Chang Hua County (TW)

(21) Appl. No.: 13/788,816

(22) Filed: Mar. 7, 2013

(51) Int. Cl. F16C 1/26

(52) U.S. Cl. CPC F16C 1/267
USPC 74/502.5

(57) ABSTRACT

A cable for a vehicle is provided. The cable includes a center line, a first sleeve, a second sleeve and an outmost sheath. The first sleeve is disposed around the center line and axially movable relative to the center line. The second sleeve is disposed around the first sleeve and axially movable relative to the first sleeve. The outmost sheath is disposed around the second sleeve, and the second sleeve is axially movable relative to the outmost sheath. Whereby, the friction caused due to the axial movement of the center line can be reduced so that the cable can be operated easily, smoothly and precisely; and the center line can be prevented from being damped and rusted so that the cable can function well and the durability thereof is enhanced.

### BACKGROUND OF THE INVENTION

1. Field of the Invention

The present invention relates to a cable, more particularly, to a cable for a vehicle.

2. Description of the Prior Art

Generally, a cable applied to a brake or derailleur of a vehicle such as bicycle or motorcycle is constructed of a plurality of wires, and an outmost sheath is disposed around substantially an entire length of the cable. The brake or derailleur can be controllably driven through the cable driven by a brake lever or shift lever.

The cable, generally, is made by wringing so that it has a twisted circumferential surface, and the cable is telescoped by the outmost sheath along the entire length thereof. As such, it can cause great frictional resistance between the cable and the inner surface of the outmost sheath so as to disadvantage the operation and control of the brake; as the cable and the outmost sheath which always contact each other are used for a long time, the cable and/or the outmost sheath can be abraded and should be replaced. Additionally, water and dust can come into the gap between the cable and the outmost sheath easily, so that the cable is damped and rusted easily, and is not durable.

Besides, in some conventional structures, plural layers are disposed sequentially around a cable to reduce the frictional resistance between the cable and the inner surface of the outmost sheath so as to avoid the abrasion and damage of the cable. However, the layers are not movable and not slidable with each other, which can still cause great frictional resistance between the cable and the inner surface of the outmost sheath. As such, the layers and/or the cable can be abraded or damaged as they are used for a long time, and hence the layers and/or the cable are not durable and should be replaced frequently.

The present invention is, therefore, arisen to obviate or at least mitigate the above mentioned disadvantages.

### SUMMARY OF THE INVENTION

An object of the present invention is to provide a cable for a vehicle, in which the friction caused due to the axial movement of the center line can be reduced so that the cable can be operated easily, smoothly and precisely; and the center line can be prevented from being damped and rusted so that the cable can function well and the durability thereof is enhanced.

To achieve the above and other objects, a cable for a vehicle includes a center line, a first sleeve, a second sleeve and an outmost sheath. The first sleeve is disposed around the center line and axially movable relative to the center line. The second sleeve is disposed around the first sleeve and axially movable relative to the first sleeve. The outmost sheath is disposed around the second sleeve, and the second sleeve is axially movable relative to the outmost sheath.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing according to a preferred embodiment of the present invention;

FIG. 2 is a longitudinal cross-sectional view of FIG. 1;

FIG. 3 is a radial cross-sectional view of FIG. 1;

FIG. 4 is a perspective drawing according to an alternative embodiment of the present invention;

FIG. 5 is a perspective drawing according to another embodiment of the present invention;

FIG. 6 is partial cross-sectional view of FIG. 5;

FIG. 7 is a drawing showing a cable applied to a bicycle according to a preferred embodiment of the present invention;

FIG. 8 is a partial view of FIG. 7; and

FIG. 9 is a drawing showing a cable applied to a bicycle according to an alternative embodiment of the present invention.

### DETAILED DESCRIPTION OF THE PREFERRED EMBODIMENTS

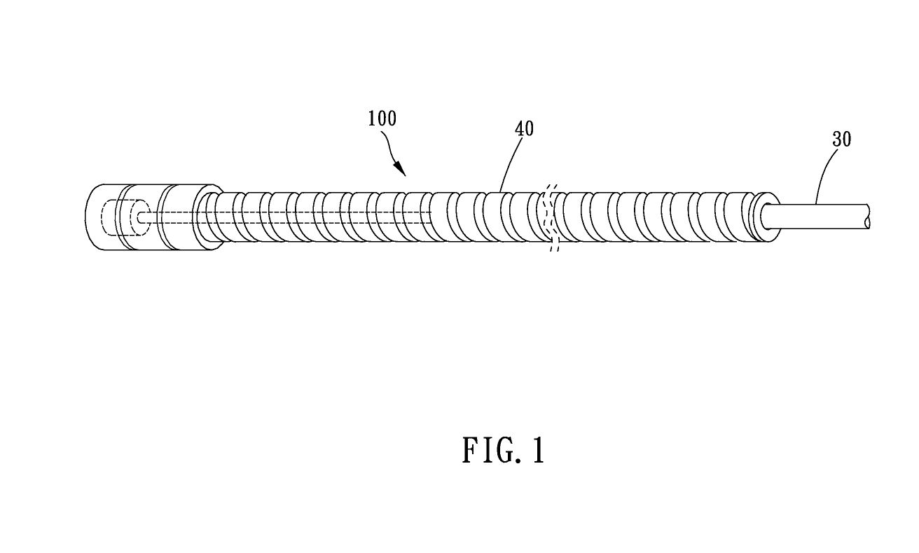

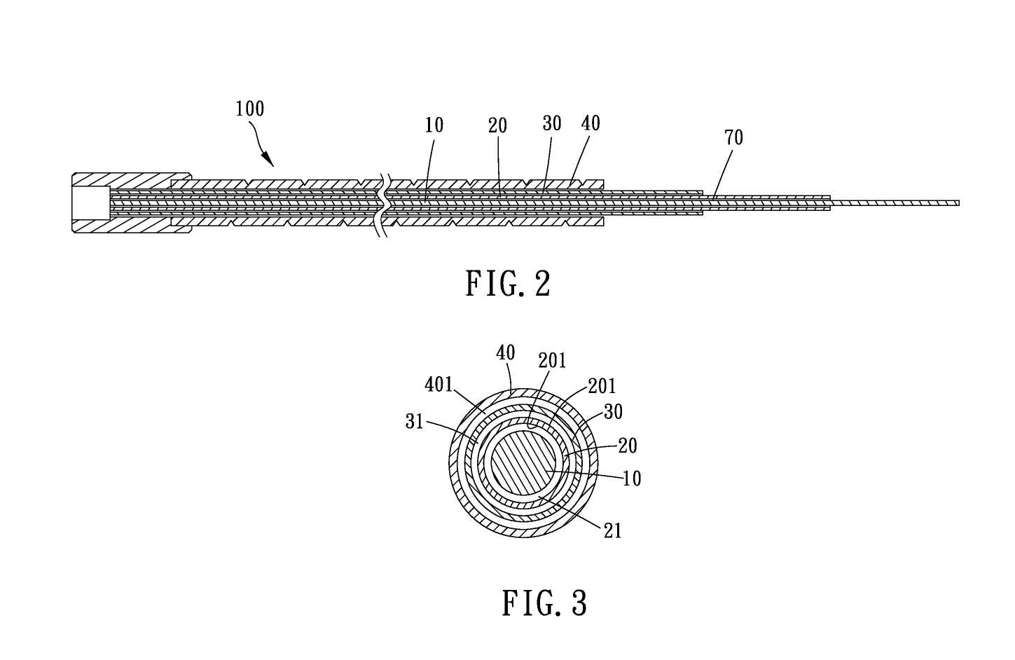

FIGS. 1 to 3 show a cable for a vehicle 100 according to a preferred embodiment of the present invention. The cable 100 includes a center line 10, a first sleeve 20, a second sleeve 30 and an outmost sheath 40.

The center line 10 may be made of wires which are wrung and has a twisted circumferential surface, or the center line 10 may be made of a single wire and has a smooth circumferential surface.

The first sleeve 20 is disposed around the center line 10 and is axially movable relative to the center line 10. Preferably, the first sleeve 20 and the center line 10 form a first gap 21 therebetween; however, the first sleeve 20 can slightly contact the center line 10. Preferably, a thin layer 201 having self-lubricating property is disposed at least on inner and outer circumferential surfaces of the first sleeve 20. The thin layer 201 may be made of polytetra fluoroethylene (PTFE, teflon), phenol (PHENOL), ultra-high-molecular-weight polyethylene (UHMW-PE), polypropylene (PP), polyetherether ketone (PEEK), polyphenylene sulfide (PPS) or polychlorotrifluoroethene (PCTFE). The first sleeve 20 may be wholly made of one of the aforementioned self-lubricating materials, or just the inner and outer circumferential surfaces of the first sleeve 20 are provided with two of the aforementioned self-lubricating materials respectively. Preferably, the first sleeve 20 is continuously disposed around substantially an entire length of the center line 10. Since the first sleeve 20 and the center line 10 form the first gap 21 therebetween and the first sleeve 20 has self-lubricating property, the frictional resistance between the center line 10 and the first sleeve 20 having self-lubricating property can be reduced so as to make a motion such as brake easily, smoothly and precisely.

The second sleeve 30 is disposed around the first sleeve 20 and axially movable relative to the first sleeve 20. The first sleeve 20 and the second sleeve 30 form a second gap 31 therebetween; however, the second sleeve 30 can slightly contact the first sleeve 20. In this embodiment, the second sleeve 30 is disposed around substantially an entire length of the first sleeve 20. However, according to various requirements, the second sleeve 30 may be longer or shorter than that the first sleeve 20 in length. Preferably, the second sleeve 30 is made of plastic material such as polyurethane (PU) or polyethylene (PE) (preferably) so that the second sleeve 30 is pretty stress-proof, vibration-proof, corrosion-proof, abrasion-proof, weather-proof, pliable, light-weight, tensile and bendable. However, the second sleeve 30 may be made of suitable metal or composite material. In this embodiment, the frictional resistance between the first sleeve 20 and the center line 10 is smaller than that between the second sleeve 30 and the first sleeve 20. As such, as the center line 10 moving axially, the second sleeve 30 is relatively uneasy to move relative to the first sleeve 20, while the center line 10 is relatively easy to move relative to the first sleeve 20, thus reducing the frictional resistance of the axially-moving center line 10 so that the cable 100 can be operated easily, smoothly and precisely.

Preferably, a lubrication matter 70 such as lubrication oil or the like is disposed between the first sleeve 20 and the center line 10, which can further reduce the frictional resistance between the center line 10 and the first sleeve 20. Additionally, the lubrication matter 70 may further encompass the center line 10 so as to prevent the center line 10 from damping and rusting and enhance the durability of the center line 10. Furthermore, the second sleeve 30 and the first sleeve 20 are axially movable relative to each other, and the second sleeve 30 and the outmost sheath 40 are also axially movable relative to each other. As a result, as the center line 10 moves axially to, probably, slight led the first sleeve 20, there will be little frictional resistances between the second sleeve 30 and the first sleeve 20 and between the second sleeve 30 and the outmost sheath 40, thus smoothing the movement of the center line 10; besides, the first gap 21 and the second gap 31 not only facilitate the assembly of the center line 10, the first sleeve 20 and the second sleeve 30 but also provide adequate and sufficient space for bend and deformation of all parts when they are fabricated so that the frictional resistances due to the contact among the center line 10, the first sleeve 20 and the second sleeve 30 are reduced as the cable is bent or deformed.

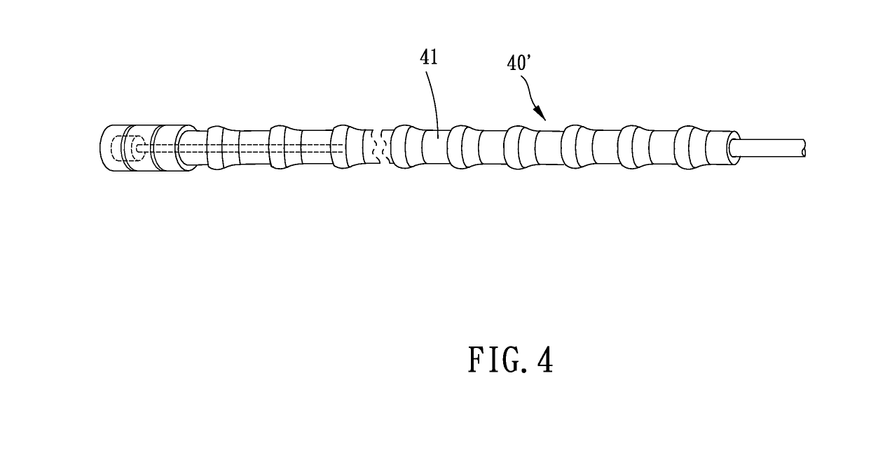

The outmost sheath 40 is disposed around and axially movable relative to the second sleeve 30. In this embodiment, the outmost sheath 40 is disposed around two end portions of the second sleeve 30; however, the outmost sheath 40 may be continuously disposed around substantially an entire length of the second sleeve 30, so as to protect the second sleeve 30 from being damaged by external objects or external forces. The outmost sheath 40 and the second sleeve 30 form a third gap 401 therebetween. The outmost sheath 40 can provide sufficient support, fixation, protection, guidance to the center line 10. The third gap 401 can reduce the frictional resistance between the outmost sheath 40 and the second sleeve 30 as the center line 10 moves axially, so that the cable 100 can be operated easily, smoothly and precisely. Preferably, the outmost sheath 40 is made of aluminum or stainless steel which is uneasy rusted and can provide good protection to the center line 10, the first sleeve 20 and the second sleeve 30. In this embodiment, the outmost sheath 40 is made of an elongate member being continuously twisted and is shaped in a generally tubular form. However, in a preferred embodiment as shown FIG. 4, an outmost sheath 40′ may include a plurality of shell members 41 detachably sequentially connected along the outmost sheath 40′ axially.

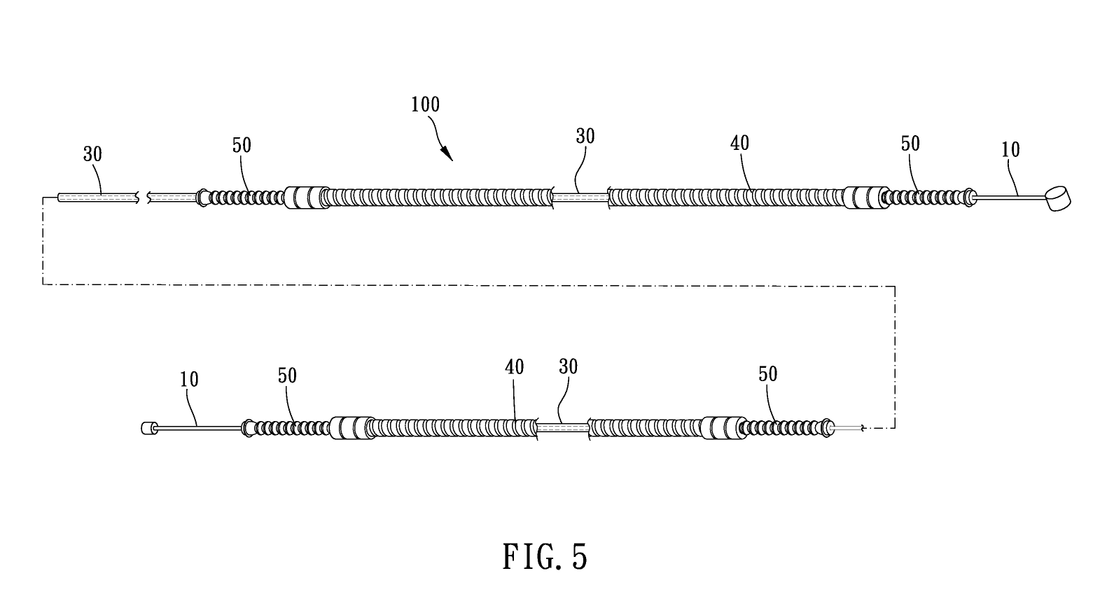

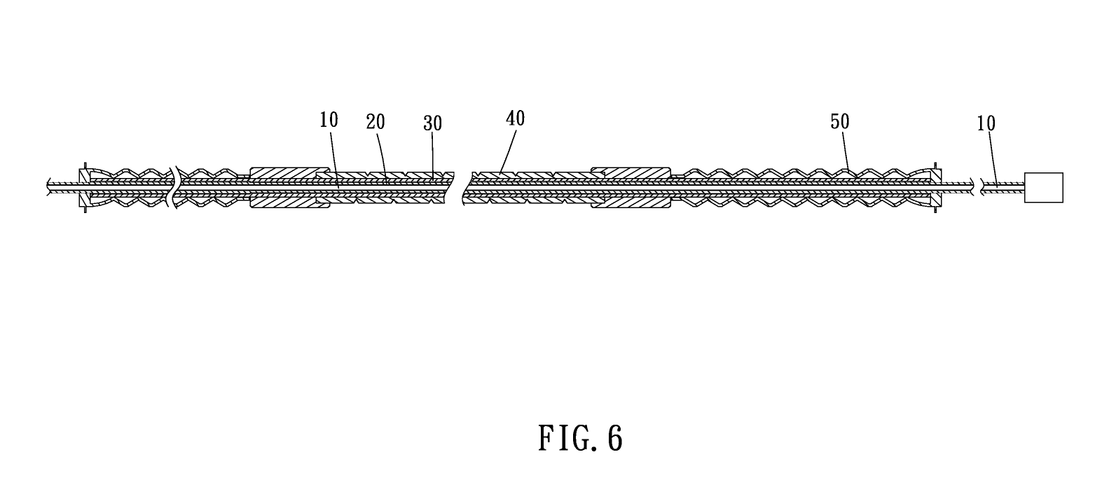

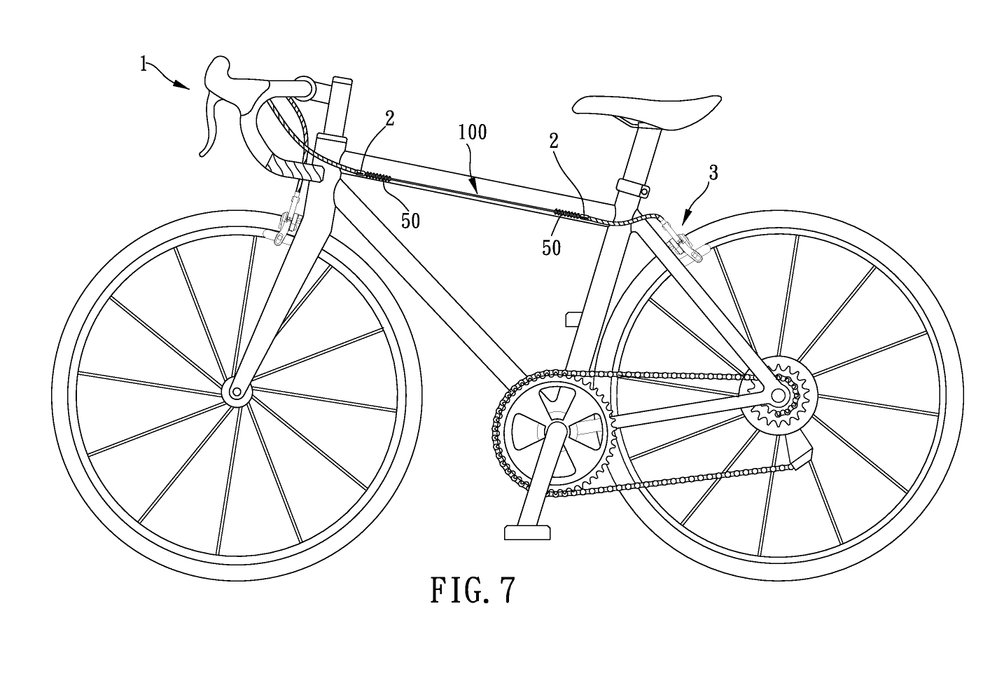

Preferably, as shown in FIGS. 5 and 6, a plurality of third sleeves 50 are disposed respectively around two end portions of the center line 10. The third sleeves 50 are preferably axially-deformable and preferably made of plastic material or rubber. The third sleeves 50 can prevent the entering of water and dust into the cable 100, so that the center line 10 can be prevented from being damped and rusted and the center line 10 can function well. Since the third sleeves 50 are axially-deformable, they are suitable to dispose in various spaces.

It is noted that the structure of the cable 100 may be suitably modified. For example, the first sleeve 20, the second sleeve 30 and the outmost sheath 40 may be telescoped around the entire length of the center line 10; or the cable 100 may be provided without any third sleeve.

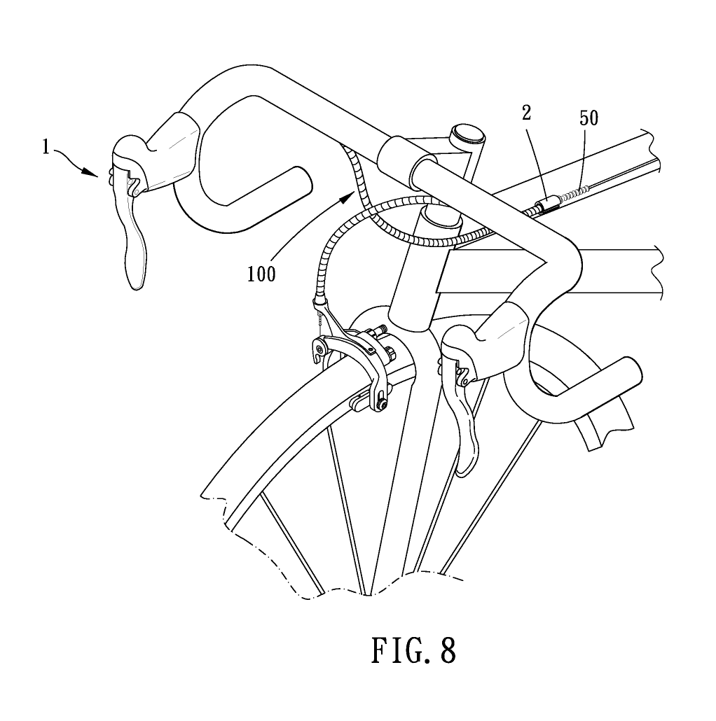

Please referring further to FIGS. 7 and 8, the cable 100 may be mounted to a vehicle (such as, but is not limited to, bicycle, motorcycle or car). The vehicle has an operable portion 1, at least two fixation portions 2 for holding the cable 100 and an operated device 3. The operable portion 1 may be a brake lever, shift lever or fluid control operator, and the operated device 3 may be a brake, derailleur or fluid control device.

Two ends of the center line 10 are connected to the operable portion 1 and the operated device 3 respectively. The operated device 3 is controllably operated by the operable portion 1 via the center line 10. For example, the center line 10 may be a brake wire, and a brake can be driven by the brake wire to make a brake through moving a brake lever to pull the brake wire.

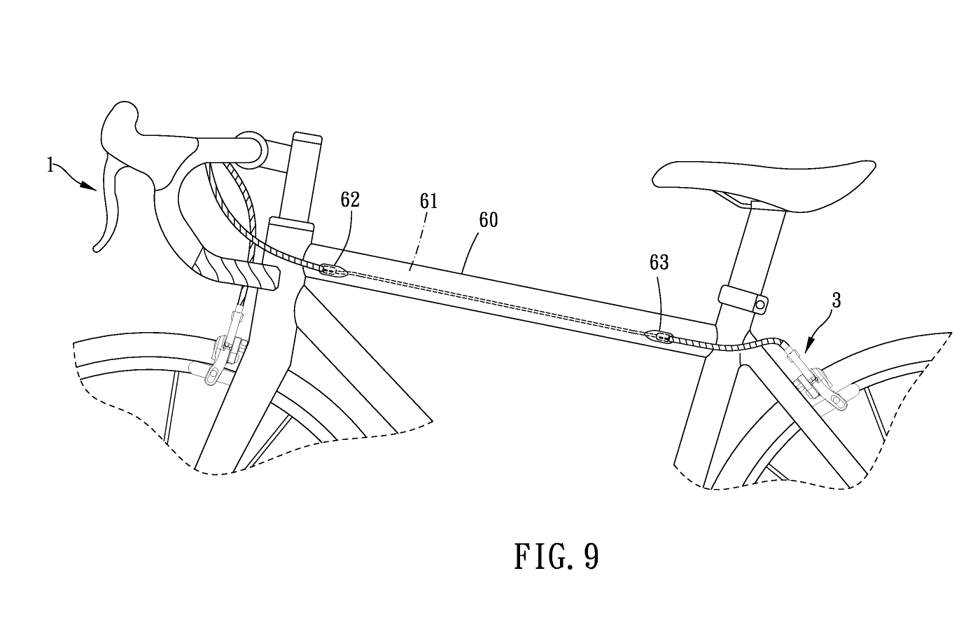

As shown in FIG. 9, in an alternative embodiment, the vehicle has a tube portion 60, wherein the tube portion 60 may be a single tube body or constructed of plural tube bodies. In this embodiment, the tube portion 60 is the top tube of a bicycle, and the tube portion 60 is formed with an inner space 61 and has two fixation portions 62, 63. The two fixation portions 62, 63, in this embodiment, are two openings communicating with the inner space. The telescoped first sleeve and the center line come into the inner space 61 via one of the openings and extend outside the tube portion 60 via the other opening. As such, the effects of preventing the first sleeve and the center line from damping and rusting are further enhanced.

Given the above, by utilizing the cable of the present invention, the friction caused due to the axial movement of the center line can be reduced so that the cable can be operated easily, smoothly and precisely; and the center line can be prevented from being damped and rusted so that the cable can function well and the durability thereof is enhanced.

Although particular embodiments of the invention have been described in detail for purposes of illustration, various modifications and enhancements may be made without departing from the spirit and scope of the invention. Accordingly, the invention is not to be limited except as by the appended claims.

1. A cable for a vehicle, for being mounted to a vehicle, the vehicle having an operable portion and an operated device, the cable including:
a center line, two ends thereof being connected to the operable portion and the operated device respectively, the center line being enable to move axially to actuate the operated device by operating the operable portion to pull the center line;
a first sleeve, disposed around the center line and being axially movable relative to the center line, wherein the first sleeve is moved by frictional drag of the center line as the center line is pulled to move axially;
a second sleeve, disposed around the first sleeve and axially movable relative to the first sleeve, wherein the second sleeve is moved by frictional drag of the first sleeve as the center line is pulled to move axially and the first sleeve is moved together therewith; and
an outmost sheath, disposed around the second sleeve, and the second sleeve being axially movable relative to the outmost sheath as the second sleeve is moved;
wherein the first and second sleeves are tubes which have continuously solid cylindrical walls respectively;
wherein the first sleeve and the center line form a first gap therebetween, and the first gap is continuously hollow cylindrical extending around the center line and through an entire length of the first sleeve;
wherein the second sleeve and the first sleeve form a second gap therebetween, and the second gap is continuously hollow cylindrical extending around the first sleeve and through an entire length of the second sleeve;
wherein the first sleeve is not connected to the center line and not naturally returnable without the pull of the center line, and the second sleeve is not connected to the first sleeve and not naturally returnable without the frictional drag of the first sleeve.

2. (canceled)

3. (canceled)

4. The cable for a vehicle of claim 1, wherein the outmost sheath and the second sleeve form a third gap therebetween, and the third gap is continuously hollow cylindrical extending around the second sleeve and through an entire length of the outmost sheath.

5. The cable for a vehicle of claim 1, wherein the frictional resistance between the first sleeve and the center line is smaller than that between the second sleeve and the first sleeve.

6. The cable for a vehicle of claim 1, wherein the first sleeve is continuously disposed around substantially an entire length of the center line.

7. The cable for a vehicle of claim 1, wherein a lubrication matter is disposed between the first sleeve and the center line.

8. The cable for a vehicle of claim 1, wherein a layer having self-lubricating property is disposed at least on inner and outer circumferential surfaces of the first sleeve, and the layer is made of polytetra fluoroethylene (PTFE, teflon), phenol (PHENOL), ultra-high-molecular-weight polyethylene (UHMW-PE), polypropylene (PP), polyetherether ketone (PEEK), polyphenylene sulfide (PPS) or polychlorotrifluoroethene (PCTFE).

9. The cable for a vehicle of claim 1, wherein the second sleeve is made of PE (polyethylene).

10. (canceled)
